(19) United States
(12) Patent Application Publication
(10) Pub. No.: US 2002/0093530 A1
(43) Pub. Date: Jul. 18, 2002

(54) Automatic filling and submission of completed forms

(76) Inventors: Prasad Krothapalli, San Jose, CA (US); Nihar Mehta, San Jose, CA (US); Mahesh Rangamani, Mountain View, CA (US); Amitabh Sinha, Redwood City, CA (US); Deviprasad Malladi, San Jose, CA (US); Dan Baca, Pleasanton, CA (US); Rajeev Mohindra, Santa Clara, CA (US)

Correspondence Address: PILLSBURY WINTHROP LLP, East Tower, Ninth Floor, 1100 New York Avenue, N.W., Washington, DC, 20005-3918, US

(21) Appl. No.: 09/765,056

(22) Filed: Jan. 17, 2001

(51) Int. Cl. G06F 3/00

(52) U.S. Cl. 345/745

(57) ABSTRACT

A method for configuring a device's interaction with an application without using cookies. The method includes entering information that needs to be used each time a transaction with an application residing on an application server is performed and storing the information at the application server. The method also includes initiating the transaction between the device and the application server, and looking up based on a user indicator an automatic entry indicator. The then includes sending from the application server the information when the automatic entry indicator is indicative of automatic entry having been enabled.

### FIELD

This invention relates to entering information into a communication device, and more specifically, to providing a facility for entering the information once and using it repeatedly without the use of cookies.

### BACKGROUND

A user navigating the internet is often faced with the need to provide information each time a website is visited. This is necessary because the hypertext transfer protocol (HTTP) used on the internet is a “stateless” (non-persistent) protocol making it impossible to differentiate between visits to a web site, unless the server can somehow “mark” a visitor. For example, a user may have to enter a password and account number every time a user desires entry into a website. To provide a more user-friendly experience in which repeated entry of the same information is no longer necessary, cookies have been developed. Cookies help make it easier for users to access their favorite internet web sites without having to go through a lengthy process of identifying themselves every time they visit. For instance, upon one's first visit to a given site, one may be asked to reveal one's name and perhaps even some personal or financial information to gain access to that site immediately and in the future. The site will then save that information on its servers and place a cookie containing a pointer to the information on the user's device. When one returns anytime later, the browser on the user's device will send the cookie to the site. By retrieving the information that the cookie points to the site is able to determine who one is and whether one has authorization to access the site, without requiring one to reenter and resubmit the information.

Cookies can store pointers to database information, custom page settings, or just about anything that would make a site individual and customizable. Cookies are very much like a laundry “claim-check” of sorts. One drops something off, and gets a ticket. When one returns with the ticket, one gets that same something back.

Unfortunately, many devices that allow a user to navigate the internet may not have the facility to store a cookie. Examples of devices that may not have the ability to store a cookie include, but are not limited to, cellular phones, personal digital assistants (PDAs), regular public switched telephone network (PSTN) telephones, and palm personal computers. This inablity may be due to a ‘non-intelligent’ browser, but there may be other reasons as well. Additionally, many of these devices have compact user input interfaces such as small keypads, keyboards—sometimes with a limited number of keys—or microphones. Entering and reentering information on these devices can be slow and cumbersome.

Since these devices do not support cookies and are likely to have input interfaces that do not provide easy and quick entry of information, it is desirable to provide a mechanism for allowing information to be entered once and used repeatedly without requiring reentry of the information by the user.

### SUMMARY

A method for configuring a device's access to an application without using cookies is described. The method includes entering information that needs to be used each time a transaction with an application residing on an application server is performed, and storing the information at the application server. The method also includes initiating a transaction between the device and the application server, and looking up based on the transaction and a user indicator an automatic entry indicator. The method then includes sending from the application server the information when the automatic entry indicator is indicative of automatic entry having been selected.

### DESCRIPTION OF THE DRAWINGS

The present invention is illustrated by way of example, and not limitation, in the figures of the accompanying drawings in which like references denote similar elements, and in which:

FIG. 1 illustrates a block diagram of a system in which wireless and wired devices communicate with an application server;

FIG. 2a illustrates entry of personalization information using a browser;

FIG. 2b illustrates entry of information by devices with a browser that does not support cookies or by devices that interact with a gateway that does not support cookies;

FIG. 2c illustrates entry of information by a device without a browser;

FIG. 3 illustrates a process for entering and storing personalization information;

FIG. 4 illustrates user information as stored in a database;

FIG. 5 illustrates a block diagram of a mobile application server;

FIG. 6 illustrates a process for auto-filling or auto-submitting personalization information.

### DETAILED DESCRIPTION

Methods and apparatus for configuring a device's access to an application without using cookies is described. In the following description, for purposes of explanation, numerous specific details are set forth in order to provide a thorough understanding of the present invention. It will be evident, however, to one skilled in the art that the present invention may be practiced in a variety of communication systems, especially wireless application protocol systems, and communications devices, especially telephones, without these specific details. In other instances, well-known operations, steps, functions and devices are not shown in order to avoid obscuring the invention.

Parts of the description will be presented using terminology commonly employed by those skilled in the art to convey the substance of their work to others skilled in the art, such as protocol, gateway, render, store, interpret, and so forth. Also parts of the description will also be presented in terms of operations performed through the execution of programming instructions or initiating the functionality of some electrical component(s) or circuitry, using terms such as, performing, sending, processing, transmitting, configuring, and so on. As well understood by those skilled in the art, these operations take the form of electrical or magnetic or optical signals capable of being stored, transferred, combined, and otherwise manipulated through electrical or electromechanical components.

Various operations will be described as multiple discrete steps performed in turn in a manner that is most helpful in understanding the present invention. However, the order of description should not be construed as to imply that these operations are necessarily performed in the order that they are presented, or even order dependent. Lastly, repeated usage of the phrases “in one embodiment,” “an alternative embodiment,” or an “alternate embodiment” does not necessarily refer to the same embodiment, although it may.

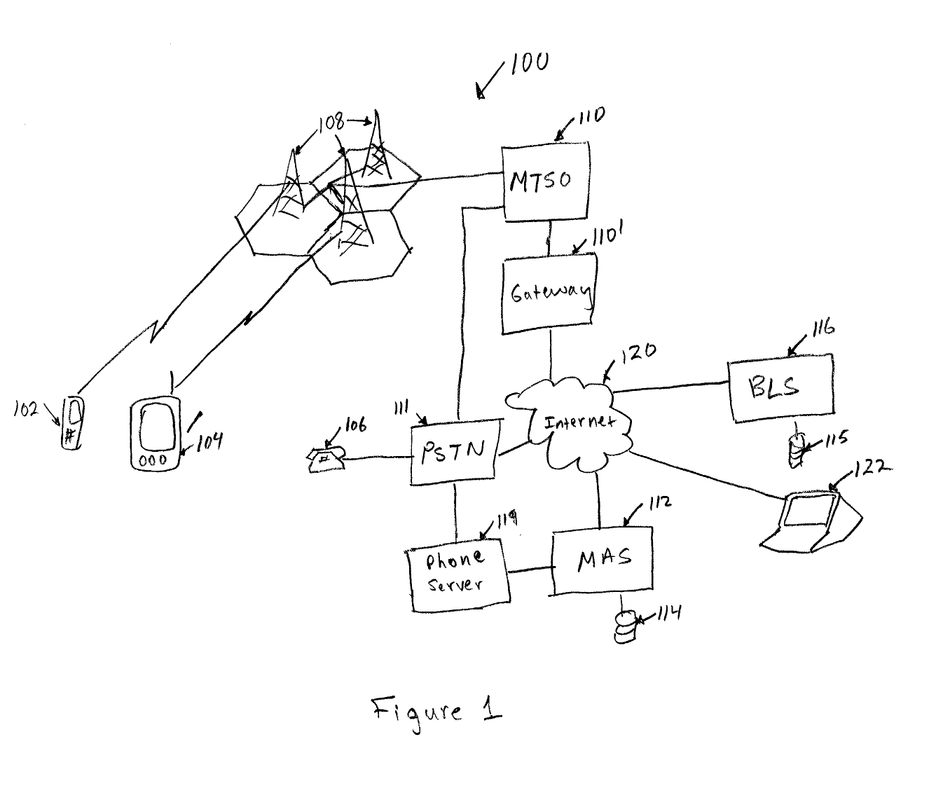

FIG. 1 illustrates a block diagram of a system in which wireless and wired devices communicate with an application server. System 100 includes mobile telephone 102, personal digital assistant (PDA) 104, telephone 106, cellular stations 108, mobile telephone switching office 110, gateway 110′, public switched telephone network switching office 111, mobile application server 112, storage 114, business logic server 116, internet 120, and computer 122. PDA 104 communicates with application server 112 by first setting up a data link with cellular station 108. Cellular station 108 relays to MTSO 110 data received from PDA 104. MTSO 110 in turn sends the data to gateway 110′. MTSO is an interface to the public switched telephone network for mobile phones making telephone calls to or receiving calls from telephones such as telephone 106. MTSO 110 directs internet traffic to and from gateway 110′ which is an interface between the wireless network and internet 120. Server 112 communicates with business logic server 116 which provides in various embodiments services including, but not limited to, retrieving stock quotes and airline flight information or sport scores, trading stock, buying and selling goods.

Business logic server 116 generates visual information such as documents providing product offerings, query pages for information such as flight or stock quotes, and pages for procuring other services. The documents can be in hypertext markup language (HTML) or another page description language. The pages can be rendered on a screen of a device. In one embodiment, business logic server 116 is unable to communicate directly with PDA 104, and telephones 102 and 106 because it generates documents that cannot be rendered on the tiny screens of PDA 104 and telephone 102 or the screenless telephone 106. Because PDA 104, telephone 102 and 106 are unable to render the documents generated by server 116, they are referred to herein as reduced content devices.

Server 112 has a software suite that permits the HTML documents to be reformatted, reduced, or represented in a different manner (for example audibly) such that the services indicated above can be provided despite the small screens of PDA 104 and telephone 102 and the lack of a screen in telephone 106. Mechanisms for extracting data from an HTML document and representing it in a manner suitable for reduced content devices is the subject of co-pending patent application “Method for Converting Two-dimensional Data into a Canonical Representation” with Ser. No. 09/394,120, filed on Sep. 10, 1999, and co-pending patent application “Method for Customizing and Rendering of Selected Data Fields” with Ser. No. 09/393,133, filed on Sep. 10, 1999.

Server 112 may represent information from an HTML document received from server 116 audibly rather than visually to a user of telephones 102 and 106. Server 112 presents information from the document in voice XML or some other language that handles voice. Server 112 sends the voice XML to phone server 119 which provides text to speech conversion. When telephone 102 is communicating through audible signals with server 112, the communication path is through stations 108, MTSO 110, PSTN 111, and server 119. Alternatively, telephone 102 can communicate in a data mode with server 112; in which case, the communication path is through stations 108, MTSO 110, and gateway 110′. When telephone 106 is communicating through audible signals with server 112, the communication path runs through PSTN 111 and server 119.

A user responds to server 112 and server 116 by pressing a key to generate a dual tone multi-frequency (DTMF) tone or speaking into the telephone's microphone. Alternatively, server 112 may provide only a portion of a document at a time on telephone 102 or PDA 104. A user would navigate from one portion of the document to another by inputting a signal to change from one portion of the document to another, whether by pressing a key, touching an area of the screen, or by some other method. Furthermore, by the aforementioned methods, a user can respond to queries and choices sent from server 112 and server 116.

In an alternative embodiment PDA 104 is a handheld personal computer. Handheld personal computers tend to have small keyboards instead of a touch screen.

As described above, telephones 102 and 106 and PDA 104 have input interfaces that do not provide easy and quick entry of information. A keypad or microphone of a telephone, a small keyboard of a small personal computer, or the touch screen of a PDA are not user-friendly input devices. In conducting the transactions to procure the services described above, a user often has to enter the same personal information each time the service is procured. For example, a buyer of a book has to enter credit card information, expiration date, and billing and shipping addresses each time the buyer tries to buy a book. It is desirable to provide a mechanism for allowing information to be entered once and used repeatedly without requiring reentry of the information by the user. Cookies allow information to be entered once and used repeatedly without requiring reentry of the information by the user. Telephones 102 and 106, and PDA 104 do not support cookies. Consequently, single entry of information and repeated usage later without reentry is not possible by way of that method. The present invention provides a mechanism for entering information once and using it later without requiring reentry in telephones, PDAs and other devices that do not support cookies. The information that is stored for later usage can be used to customize or personalize a user's procurement of services. The words personalize and customize and similar words (e.g., personalization and customization) are used herein interchangeably.

Before describing the mechanism by which information can be entered once and used later, the operation of system 100 will be described. In one embodiment, telephone 102 and PDA 104 communicate in accordance with wireless access protocol (WAP). WAP is an application environment and a group of protocols that define access of wireless devices to internet services. The application environment is uniform and does not depend on the underlying protocol for the communications air link. WAP is implemented or will be implemented on global system for mobile communications (GSM), interim standard (IS)-136, time-division multiple access (TDMA), personal communications service (PCS), and code division multiple access (CDMA), among other schemes. The present invention can be practiced with any application environment and communications protocols.

A WAP request from telephone 102 can be an hypertext protocol (HTTP) request including a URL such as http://www.services.everypath.com. Telephone 102 converts the text URL into a binary wireless session protocol (WSP) request. WSP is a protocol layer that defines efficient exchange of data between applications. Depending on the particular embodiment, the binary request is transmitted to cellular station 108 in accordance with one of the air link protocols indicated above. Station 108 forwards the binary request to MTSO 110. MTSO is the interface to the public switched telephone network for mobile phones making telephone calls to or receiving calls from telephones such as telephone 106. MTSO 110 directs internet traffic to and from gateway 110′ which is an interface between the wireless network and internet 120. Gateway 110′ converts the binary request to an HTTP request and sends the request to server 112 via internet 120.

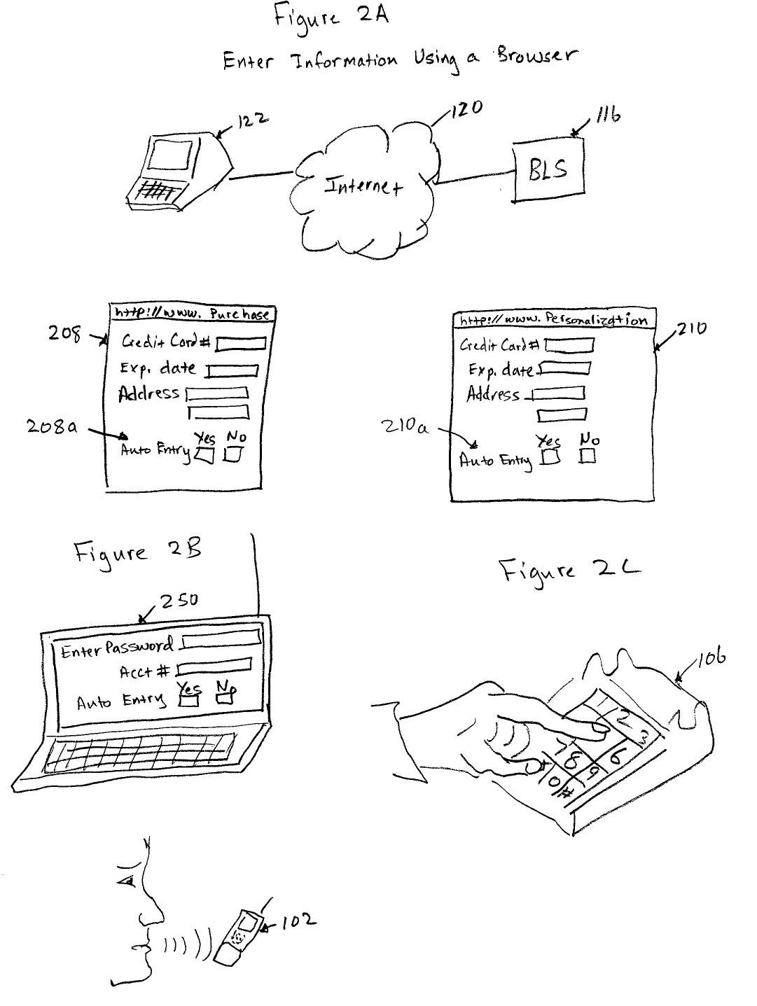

FIG. 2a illustrates entry of personalization information using a browser. System 200 is one way of providing personalization information that can be used later without requiring reentry of the information. System 200 includes a computer 122 coupled to server 116 by way of internet 120. Computer 122 has a browser that allows communication with server 116. In one embodiment, server 116 provides one or more of the services described above, and it provides a process by which procurement of the services can be customized or personalized.

A user of computer 122 can invoke a personalization process by conducting a transaction with server 116. For example, the user may attempt to purchase something provided by server 116. Since a purchase requires entry of purchase information such as credit card number, expiration date, among other information, the user eventually reaches a page which requires entry of that information in order to complete the transaction. This information is personal to the user and would need to be entered again when conducting another later transaction. Page 208 is a page requiring entry of purchase information. Page 208 also provides the user with an option 208a to have the information stored for later usage so that the information does not have to be reentered. Selecting to have the information stored for later usage is also referred to herein as enabling automatic entry. As described below, automatic entry is performed in three ways: auto-fill, auto-submit, and by an explicit user command to use previously stored information when the user is asked whether or not previously stored information is to be used. If the user selects option 208a, the purchase information entered is sent to server 112 which forwards the information to storage 114. As described below, if a user later attempts to perform the same or similar transaction using PDA 104, telephone 102, and telephone 106, server 112 retrieves the information if the user selected an option such as option 208a.

An alternative way of invoking a personalization process is for the user to provide to the browser the appropriate uniform resource locator (URL) of the web page providing the personalization process. The browser uses the URL to set up a link with server 116. After reaching the appropriate web page on server 116, the user will see on the display of computer 122 a personalization page such as personalization page 210. By entering the information requested by page 210 and selecting option 210a to have the information stored for later usage, the user will be free from having to reenter the information again when using the reduced content devices described above.

FIG. 2b illustrates entry of information for devices with a browser that does not support cookies or for devices interacting with a gateway that does not support cookies. Devices such as wireless handheld computer 250, telephone 102, and PDA 104 receive forms requesting entry of personal information from server 112 either as part of a service transaction (e.g., purchase transaction), or as part of a transaction dedicated only to entry of personal or custom information.

A device such as cellular telephone 102 allows a user to interact with server 112 which provides an audible menu of instructions or choices. The user responds either audibly or by pressing the keys on keypad 252a. By responding appropriately, the user reaches a point in the menu which demands entry of personal information and a selection of an option to store the information for later retrieval. Telephone 106 allows a similar voice or keypad interaction, but in FIG. 2c is shown as being used for responding by keypad entry only.

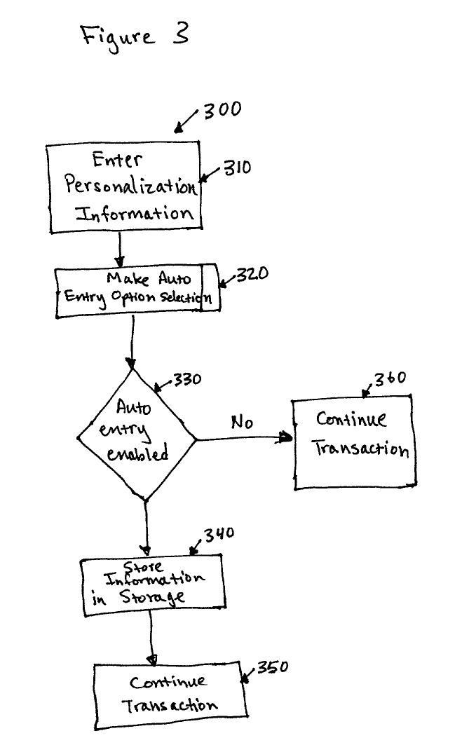

FIG. 3 illustrates a process for entering and storing personalization information. Process 300 can be part of a service transaction. Examples of service transactions include, but are not limited to, customization of a login or homepage, purchase transaction, and stock trading. At some point in the transaction personalization information is entered 310. Also automatic entry is either enabled or not enabled 320. Automatic entry is examined to determine whether it has been enabled 330. If automatic entry is enabled, the personalization information is stored 340 in storage 114 and the transaction is continued 350. If automatic entry is not enabled, the personalization information is used to perform the transaction 360, but is not saved for later usage.

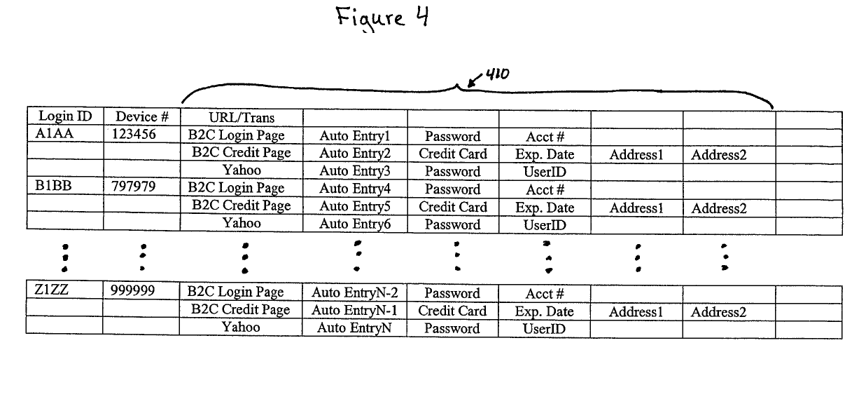

FIG. 4 illustrates user information as stored in a database. Storage 114 can store personalization information 410 and provided it to server 112 when automatic entry is enabled. In one embodiment, the personalization information 410 can be retrieved by server 112 either by providing the login ID or device #, and the type of transaction being performed or URL to storage 114.

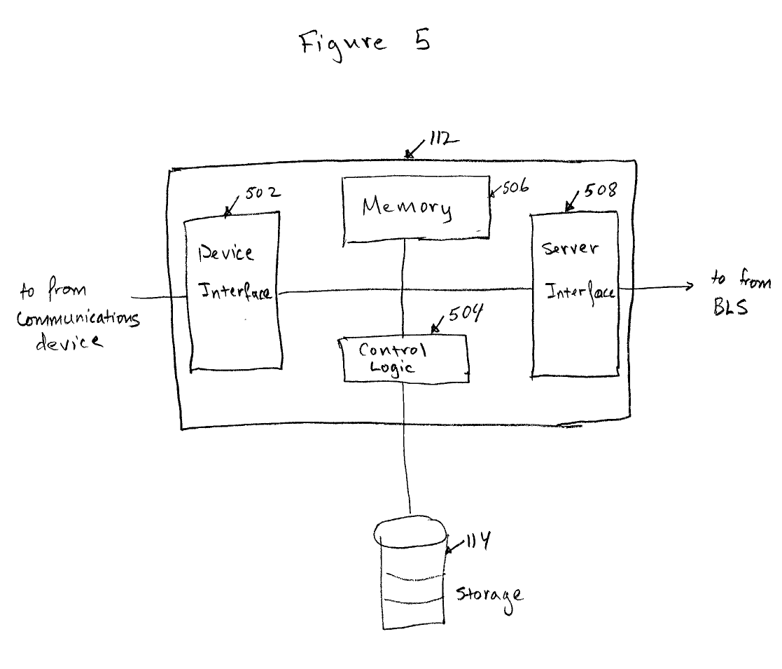

FIG. 5 illustrates a block diagram of a mobile application server. Mobile application server 112 includes a device interface 502 which receives electrical signals representative of either voice information or DTMF tones from telephones 102 or 106 by way of server 119. Additionally, interface 502 receives data from telephone 102, while it is in data mode, and PDA 104 via gateway 110′. Control logic 504 in accordance with instructions of application code in memory 506 processes the voice information, DTMF tones, or data. For example, telephones 102 and 106, and PDA 104 may request access to a service, such as one of the ones described above, that is provided by server 116 through server 112. When devices 102, 106, and 104 request access to a service that is provided by server 116, control logic 504 requests through server interface 508 the HTML documents associated with the service.

Some of the documents may include forms that require personalized information for a user. From the rendering instructions stored in storage 114 and that are associated with the documents, control logic 504 recognizes that personalized information is needed. Generating rendering instructions that are indicative that personalization information is needed is the subject matter of co-pending application “Method for Customizing and Rendering of Selected Data Fields” with Ser. No. 09/393,133 filed on Sep. 10, 1991. When control logic 504 detects that the form requires personalized information for a user, it sends the device # or login ID, and the type of transaction being performed or URL to storage 114. Storage 114 looks up an auto entry indicator that is associated with these parameters. For example, assuming storage 114 has a database organized with user information as in FIG. 4, if control logic 504 sends to storage 114 A1AA for login ID and B2C Credit Page for URL/Transaction, storage 114 looks up the automatic entry indicator based on these parameters and responds to logic 504 with Auto Entry2. Logic 504 examines Auto Entry2 to determine whether auto-fill or auto-submit is enabled. If auto-fill is enabled, logic 504 retrieves from storage 114 the credit card number, expiration date, and billing and shipping addresses and uses them to fill the form it sends PDA 104 or telephone 102. Consequently, PDA 104 or telephone 102 receives a form with the personal information already entered in it. The user can either accept the personal information or change it. If auto-submit is enabled, logic 504 retrieves from storage 114 the personal information indicated above and sends that information to server 116 which uses it to complete a transaction. If the user did not enable auto entry, the user fills in the necessary personal information.

While in the above description control logic 504 generates data for graphical or text displays that already contain personal information, when control logic 504 is communicating with telephone 106 it generates voice XML or some other voice language. Phone server 119 based on the voice XML generates audible signals which indicate to the user the personal information that will be used unless the user indicates otherwise. If the user indicates that the personal information provided to the user is not to be used, control logic 504 generates voice XML for server 119 to request the user of telephone 106 to provide substitute personal information.

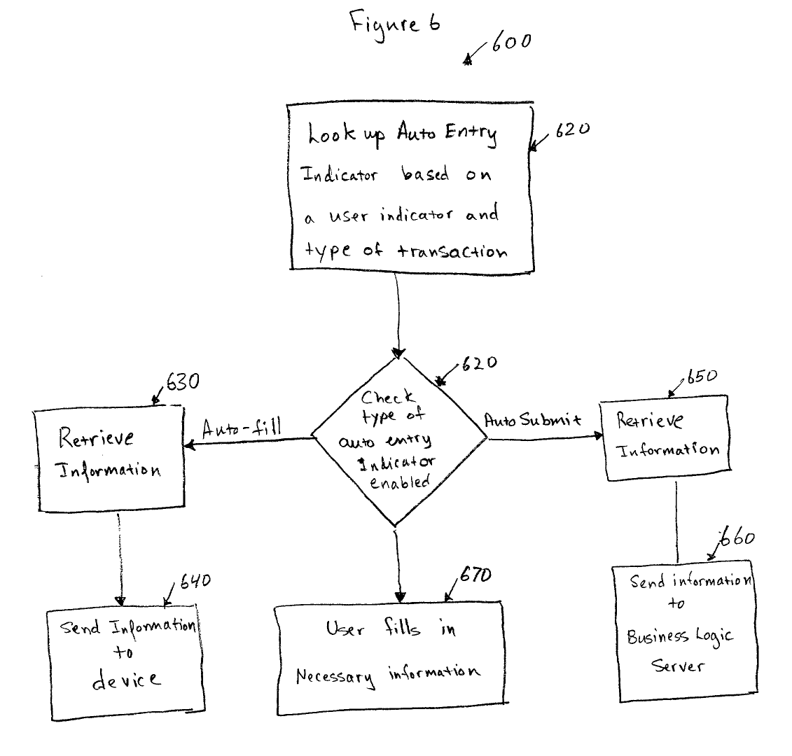

FIG. 6 illustrates a process for auto-filling or auto-submitting personalization information. As described above, while a service is being provided, a user of telephones 102 and 106, and PDA 104 reaches a point at which server 112 is about to send to the user a form which requires that personalized information be entered or needs personalized information to be sent to server 116 so that it can complete a transaction. Process 600 allows previously entered personalized information to used so that the user does not have to reenter the information into a form or reenter the information so that it can be sent to server 116. When server 112 reaches the point where it needs personalized information for a user, it sends the device # or login ID, and the type of transaction being performed or URL to storage 114. Storage 114 looks up an auto entry indicator that is associated with these parameters. For example, assuming storage 114 has a database organized with user information as in FIG. 4, if server 112 sends to storage 114 A1AA for login ID and B2C Credit Page for URL/Transaction, storage 114 will look up the automatic entry indicator based on these parameters 610 and respond to server 112 with Auto Entry2. Server 112 will examine Auto Entry2 to determine whether auto-fill or auto-submit is enabled 620. If auto-fill is enabled, server 112 retrieves from storage 114 the credit card number, expiration date, and billing and shipping addresses 630 and uses them to fill the form it sends PDA 104 or telephone 102, 640. Consequently, PDA 104 or telephone 102 receives a form with the personal information already entered in it. The user can either accept the personal information or change it. If auto-submit is enabled, server 112 retrieves from storage 114 the personal information indicated above 650 and sends that information to server 116 which uses it to complete a transaction 660. If the user did not enable auto entry, the user fills in the necessary personal information 670.

Thus, methods and apparatus for configuring a device's access to an application have been described. Although the present invention has been described with reference to specific exemplary embodiments, it will be evident to one of ordinary skill in the art that various modifications and changes may be made to these embodiments without departing from the broader spirit and scope of the invention as set forth in the claims. Accordingly, the specification and drawings are to be regarded in an illustrative rather than a restrictive sense.

We claim:

1. A method for configuring a device's interaction with an application without using cookies, the method comprising:
entering information that needs to be used each time a transaction with an application residing on an application server is performed;
storing the information at the application server;
initiating the transaction between the device and the application server;
looking up based on a user indicator an automatic entry indicator; and
sending from the application server the information when the automatic entry indicator is indicative of automatic entry having been enabled.

2. The method of claim 1, further comprising receiving the information at the device when the automatic entry indicator is indicative of automatic filling-in having been enabled.

3. The method of claim 2, further comprising rendering visually at the device the information.

4. The method of claim 1, further comprising receiving the information at a business logic server instead of the device when the automatic entry indicator is indicative of automatic submission having been enabled.

5. The method of claim 1, wherein initiating a transaction includes making a voice indication.

6. The method of claim 1, wherein initiating a transaction includes making a keypress.

7. The method of claim 1, further comprising requesting a user to indicate whether automatic entry is to be enabled.

8. The method of claim 7, wherein requesting is vocal.

9. The method of claim 1, wherein entering the information includes providing the information at the device by a user.

10. The method of claim 9, wherein entering the information occurs before the transaction is initiated.

11. The method of claim 10, further comprising:
initiating the transaction for a second time; and
completing the transaction without having to enter the information again.

12. The method of claim 1, wherein entering the information includes selecting to have the information stored at the application server.

13. The method of claim 1, wherein the information includes a password and a user identifier.

14. The method of claim 1, wherein initiating the transaction includes wirelessly initiating the transaction.

15. The method of claim 1, wherein the user indicator is a device identifier.

16. The method of claim 1, further comprising selecting to have the information stored at the application server.

17. A method for configuring a device's interaction with an application without using cookies, the method comprising:
providing at an application server information that needs to be used each time a transaction with an application residing on an application server is performed;
initiating a transaction between the device and the application server;
looking up based on the transaction and a user indicator an automatic entry indicator; and
sending from the application server the information when the automatic entry indicator is indicative of automatic entry having been enabled.

18. The method of claim 17, wherein providing includes:
entering information that needs to be used each time an application residing on an application server is accessed; and
storing the information at the application server.

19. The method of claim 17, further comprising receiving the information at the device when the automatic entry indicator is indicative of automatic filling-in having been enabled.

20. The method of claim 17, further comprising rendering visually at the device the information.

21. The method of claim 17, further comprising receiving the information at a business logic server instead of the device when the automatic entry indicator is indicative of automatic submission having been enabled

22. An apparatus that permits a device's interaction with an application to be configured without using cookies, the apparatus comprising:
memory for storing an application;
control logic is coupled to the memory and is to conduct transactions with a device based upon instructions of the application;
the control logic in response to a transaction initiated by the device is adapted to retrieve based on a user indicator an automatic entry indicator stored in a storage device coupled to the apparatus; and
the control logic is also adapted to have the information sent from the apparatus when the automatic entry indicator indicates that automatic entry is enabled.
